(19) United States
(12) Patent Application Publication
(10) Pub. No.: US 2016/0371242 A1
(43) Pub. Date: Dec. 22, 2016

(54) Method for Embedding Interactive Multimedia into Electronic Books

(71) Applicant: Lynda Chervil, Warwick, NY (US)

(72) Inventor: Lynda Chervil, Warwick, NY (US)

(21) Appl. No.: 15/246,961

(22) Filed: Aug. 25, 2016

Related U.S. Application Data
(63) Continuation-in-part of application No. 15/147,534, filed on May 5, 2016.
(60) Provisional application No. 62/209,498, filed on Aug. 25, 2015.
(60) Provisional application No. 62/180,979, filed on Jun. 17, 2015.

(51) Int. Cl. G06F 17/24; G06Q 30/02; H04L 29/08; G06F 17/22; G06F 17/21

(52) U.S. Cl. CPC G06F 17/24; G06F 17/2235; G06F 17/2264; G06F 17/212; H04L 67/306; G06Q 30/0269

(57) ABSTRACT

A method for embedding interactive multimedia into an electronic book is provided with a PC device. The electronic book is stored within the PC device in a foreign computer-readable format. A format translation method is used to convert the electronic book into a universal computer-readable format so that the electronic book can be read on any electronic book reader. Additionally, a marketing aspect of the method allows at least one piece of marketing material to be integrated into a specific storyline section of the electronic book. This allows the reader to get a better understanding of the specific storyline section. Also, the producer of the product or service mentioned in the piece of marketing material has the opportunity to expand their customer base through the electronic book.

The current application claims a priority to the U.S. Provisional Patent application Ser. No. 62/209,498 filed on Aug. 25, 2015.

### FIELD OF THE INVENTION

The present invention relates generally to electronic books. More specifically, the present invention introduces a method for using electronic books on a wide variety of devices through a universal electronic book format. Additionally, the present invention contains a marketing aspect, which allows different marketing material to be embedded into the electronic book.

### BACKGROUND OF THE INVENTION

In general, an electronic book, commonly known as an e-book, is a book publication in digital form, consisting of text, images, or both. The cheaper prices and the convenience in obtaining an e-book has led to many readers to switch to e-books. Even though e-books have numerous benefits such as instant availability, being portable, and being environmentally friendly, there are some notable disadvantages too.

Commercially produced e-books are intended to be read on e-readers. Typically, e-readers only support one format of the e-book. As a result, a specific e-book may not be available on multiple e-readers or would have formatting changes when read on a different e-reader. The inability to be displayed on multiple devices is one of the main disadvantages with existing e-books. The inability limits the number of readers that can be reached. If the user intends on having access to different types of e-books, multiple e-readers need to be purchased. However, since e-readers are costly, purchasing multiple e-readers can be financially disadvantageous to the reader. This can ultimately reduce the number of users utilizing e-books due to the related cost. Therefore, the need for the e-books to be compatible with all e-readers is clearly evident.

Another disadvantage of existing e-books is the inability to include advertisements along with the e-book. Resultantly, the publisher does not generate the maximum revenue that can be generated from an e-book. By including advertisements within the e-book, a producer of a certain product or service can gain more exposure. Moreover, the publisher can also reduce costs related to publishing the e-book.

The objective of the present invention is to address the aforementioned issues. A technology aspect of the present invention expects to improve the overall reading experience of the user by making e-books to be compatible any e-reader. Therefore, the user can experience all aspects of the e-book regardless of the device that is being used to access the material. On the other hand, a marketing aspect of the present invention allows marketing material to be added along with a storyline or a plot of the e-book. This not only helps generate more revenue for the publisher of the e-book, it also helps the user get a better understanding of the content of the e-book.

Moreover, the present invention is configured to allow for rich interactive multimedia content to be added to e-books across all formats. Consequently, this interactive multimedia content creates the ability to include or to embed marketing and advertising messages into the content of e-books. These marketing and advertising messages act as a new communication channel to advertise or to market products and services through e-book readers.

### BRIEF DESCRIPTION OF THE DRAWINGS

FIG. 1 is a flowchart illustrating the basic overall process of the present invention.

FIG. 2 is a flowchart illustrating the process flow when the written content is audibly outputted from the speaker.

FIG. 3 is a flowchart illustrating the process flow when the written content is visually outputted through the display screen.

FIG. 4 is a flowchart illustrating the process flow when the visual content is visually outputted through the display screen.

FIG. 5 is a flowchart illustrating the process flow when the piece of marketing material is integrated into a specific storyline section of the electronic book.

FIG. 6 is a flowchart illustrating the process flow wherein audible portions for the piece of marketing material is outputted through the speaker.

FIG. 7 is a flowchart illustrating the process flow wherein visual portions for the piece of marketing material is outputted through the display screen.

FIG. 8 is a flowchart illustrating the process flow wherein reading user habits of a specific profile are monitored for contextually catering marketing material.

### DETAIL DESCRIPTIONS OF THE INVENTION

All illustrations of the drawings are for the purpose of describing selected versions of the present invention and are not intended to limit the scope of the present invention.

The present invention introduces a method that can be used for including interactive multimedia within an electronic book. The interactive multimedia helps the user visualize the content of the electronic book more comprehensively. Additionally, the present invention also allows external marketing material to be included along with the content of the electronic book. The added benefit of being compatible with all electronic reading devices helps a wide variety of users utilize the electronic book.

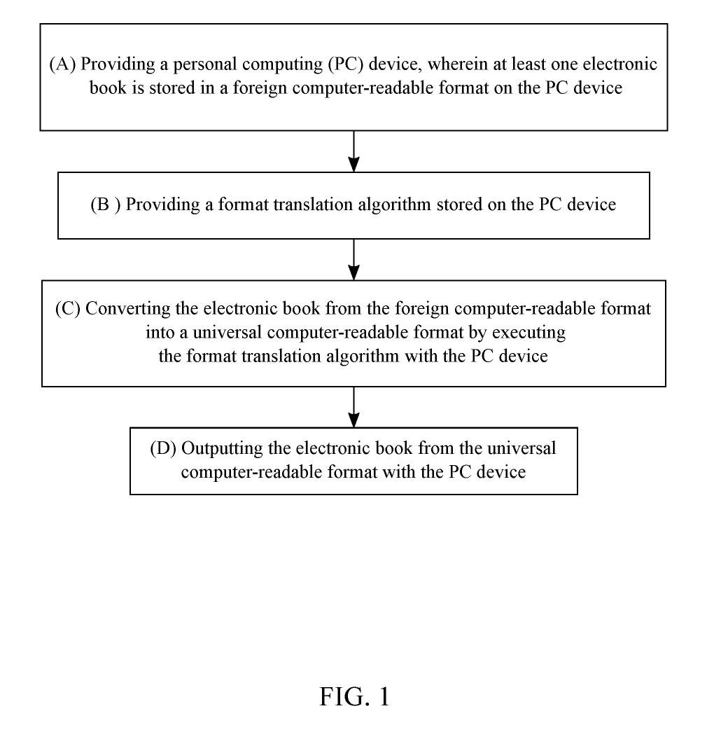

As illustrated in FIG. 1, in the process of including interactive multimedia, the present invention is provided with a personal computing (PC) device. The PC device is an electronic reader in the preferred embodiment of the present invention. The PC device is used to store at least one electronic book in a foreign computer-readable format. Storing on the PC device is executed by downloading the electronic book from an application store or other comparable methods. The computer-readable format can vary according to the PC device that is been used. In order to make the electronic book available for all electronic book reading devices, a technology aspect of the present invention is provided with a format translation algorithm which is stored on the PC device. Being stored on the PC device allows the user to have access to the functionalities of the present invention even when offline. The format translation algorithm is used to make the electronic book compatible with different electronic book reading devices. When the present invention is in use, the present invention converts the electronic book from the foreign computer-readable format into a universal computer-readable format by executing the format translation algorithm with the PC device. When completed, the present invention then outputs the electronic book in the universal computer-readable format with via the PC device. The universal computer-readable format allows the electronic book to be read on any electronic book reading device regardless of the initial foreign computer-readable format that was used for the electronic book.

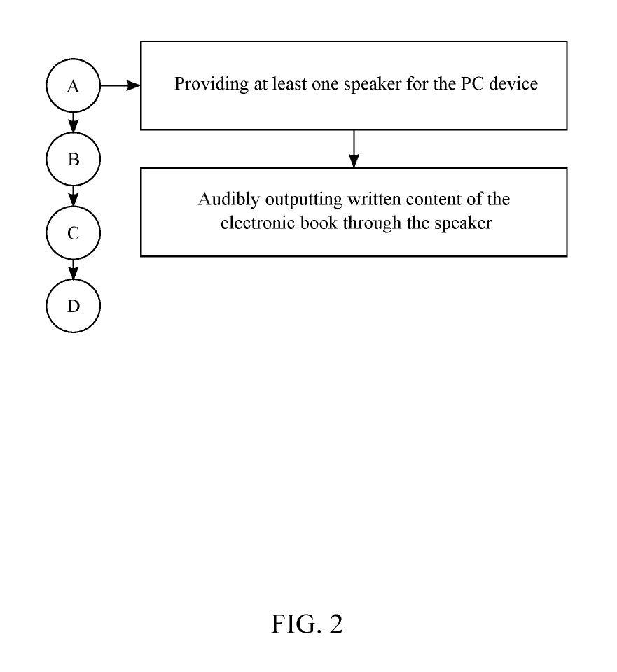

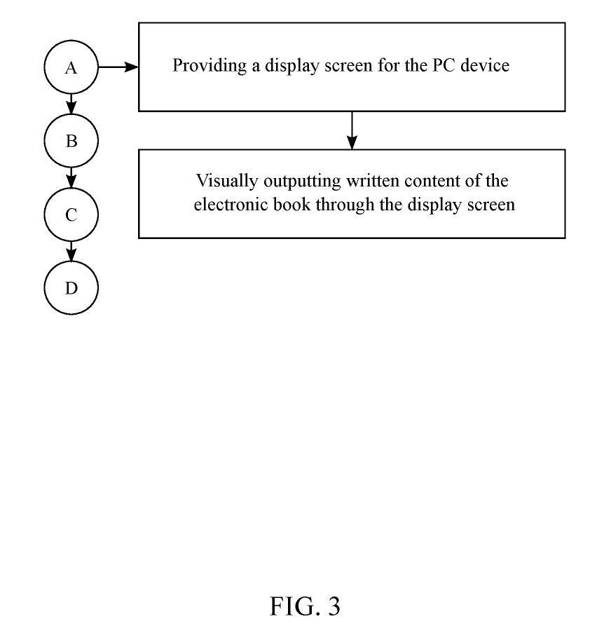

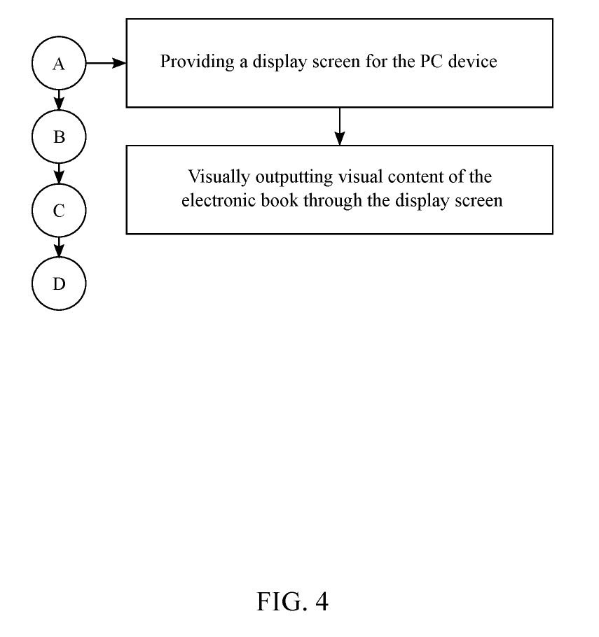

Since the present invention embeds interactive multimedia into the electronic book, the PC device needs to have the ability to support interactive multimedia files. In order to do so, at least one speaker is provided for the PC device. To better engage the user of the present invention, the speaker is used to audibly output written content of the electronic book as illustrated in FIG. 2. The PC device is also provided with a display screen which is used to visually output the written content of the electronic book as in FIG. 3. More specifically, the user utilizes the display screen to view the written content electronic book. In addition to the written content, the display screen is also used to visually output visual content of the electronic book as illustrated in FIG. 4. As an example if the electronic book is a novel, the visual content can refer to a portion of the novel. The visual content can be, but is not limited to, being a plurality of videos or a plurality of images. In order to provide user convenience, the present invention allows the user to view the electronic book in either a landscape layout or a portrait layout.

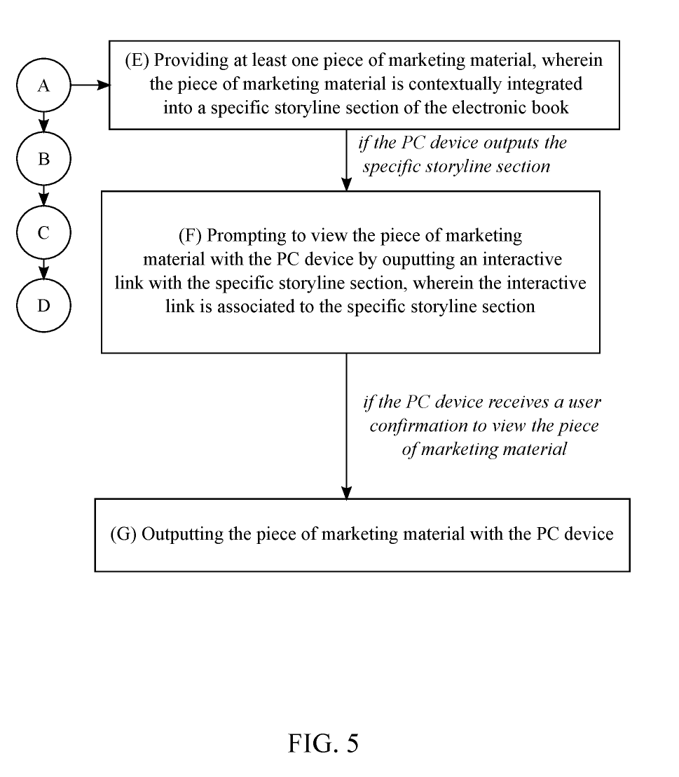

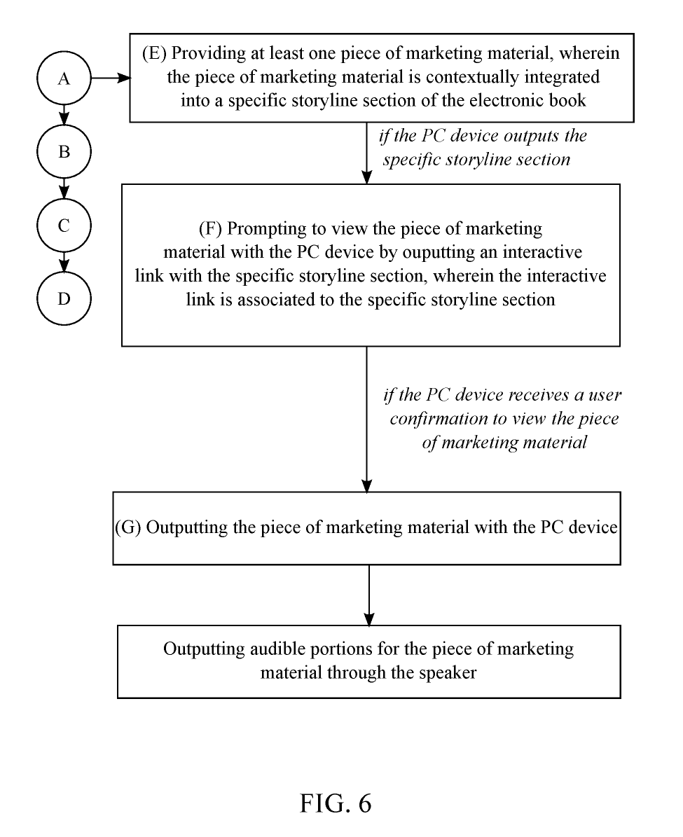

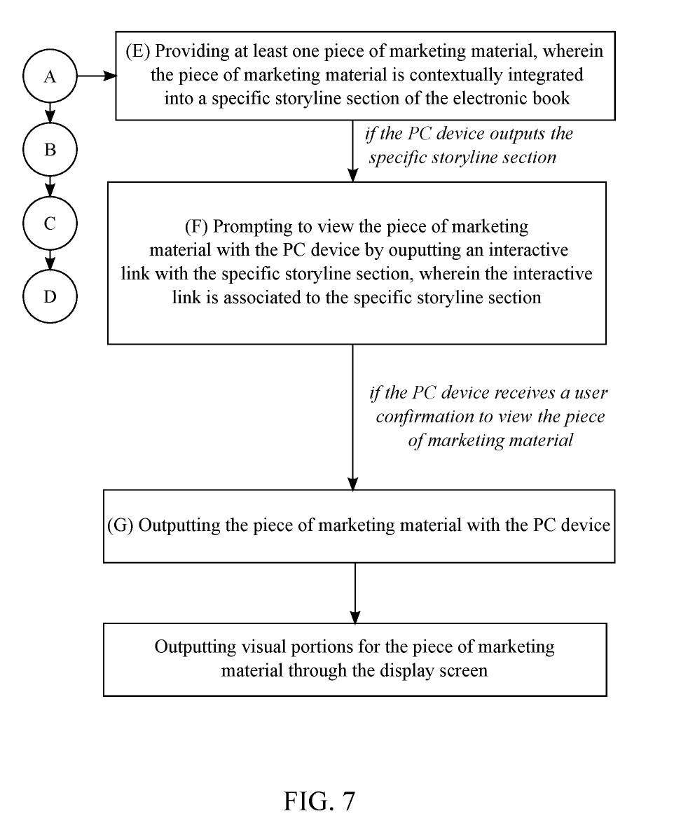

As mentioned earlier, the present invention allows external marketing material to be included along with the electronic book. In order to do so, the present invention is provided with at least one piece of marketing material as shown in FIG. 5. The piece of marketing material is contextually integrated into a specific storyline section of the electronic book. By doing so, the user of the electronic book gets a better understanding of the specific storyline section while the publisher of the piece of marketing material gets more exposure in the consumer market. In the process of displaying the piece of marketing material, the present invention initially prompts to view the piece of marketing material with the PC device if the specific storyline section is outputted by the PC device. Next, if the PC device receives a user confirmation to view the piece of marketing material the piece of marketing material is outputted with the PC device as shown in FIG. 5. The user confirmation ensures that the at least one piece of marketing material does not hinder the reading experience of the user. In the preferred embodiment of the present invention, the piece of marketing material is made available through an interactive link which is associated with the specific storyline section. More specifically, the present invention prompts to view the piece of marketing material with the PC device by outputting the interactive link with the specific storyline section. The piece of marketing material can vary in different embodiments of the present invention. As in FIG. 6, if the piece of marketing material consists of audible portions, the present invention outputs the audible portions for the piece of marketing material through the speaker. On the other hand, if the piece of marketing material consists of visual portions, the present invention outputs the visual portion for the piece of marketing material through the display screen as shown in FIG. 7.

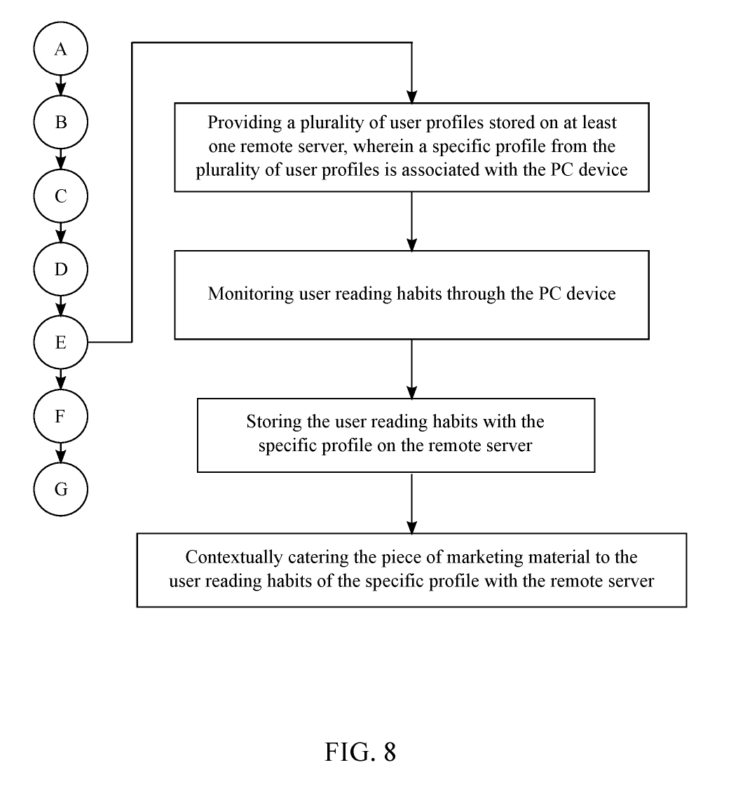

As seen in FIG. 8, third party analytics may be generated as a sub-process of the present invention. More specifically, the present invention is equipped with the ability to provide customized marketing material to the user. In order to do so, the present invention is provided with a plurality of user profiles which is stored on at least one remote server. A specific profile from the plurality of user profiles is associated with the PC device so that the present invention can monitor user reading habits through the PC device. User reading habits such as geographical location of each of the plurality of user profiles, what multimedia assets have been downloaded by each of the plurality of user profiles, and the time spent on each of the downloaded multimedia assets are monitored through the PC device. After monitoring, the present invention stores the user reading habits with the specific profile on the remote server. Next, the present invention contextually caters the piece of marketing material to the user reading habits of the specific profile according to the information from the remote server.

When the present invention is in use, the following process flow is generally followed. Initially, the electronic book is stored in the foreign computer-readable format on the PC device. In order to be compatible with any available PC device, the present invention converts the electronic book from the foreign computer-readable format to the universal computer-readable format through the format translation algorithm. Written content of the electronic book is either audibly outputted through the speaker or the written content is visually outputted through the display screen. This allows the user thoroughly understand the written content. As discussed earlier, a landscape layout or a portrait layout is used to view the electronic book according to user preference. Next, if the piece of marketing material is to be accessed, the user selects the interactive link so that the piece of marketing material integrated into the specific storyline section can be accessed. Similar to audibly outputting the written content, the present invention outputs the audible portions of the piece of marketing material through the speaker. Moreover, the visual portions of the piece of marketing material is outputted through the display screen. The piece of marketing material not only give the reader a better understanding of the written content, but also gives valuable exposure to the manufacturer of the piece of marketing material.

By utilizing the present invention, the limitations of most electronic book reading devices can be eliminated. Most importantly, the compatibility issue is resolved since the present invention utilizes the universal computer-readable format. Additionally, the present invention addresses the issue of presenting marketing material along with the electronic book content. The marketing aspect of the present invention allows the user to have a pleasurable reading experience while providing manufacturers of piece of marketing material with the ability to reach different consumer markets.

Although the invention has been explained in relation to its preferred embodiment, it is to be understood that many other possible modifications and variations can be made without departing from the spirit and scope of the invention as hereinafter claimed.

What is claimed is:

1. A method for embedding interactive multimedia into an electronic book, the method comprises the steps of:
providing a personal computing (PC) device, wherein at least one electronic book is stored in a foreign computer-readable format on the PC device;
providing a format translation algorithm stored on the PC device;
converting the electronic book from the foreign computer-readable format into a universal computer-readable format by executing the format translation algorithm with the PC device; and
outputting the electronic book from the universal computer-readable format with the PC device.

2. The method for embedding interactive multimedia into an electronic book, the method as claimed in claim 1 further comprises the steps of:
providing at least one speaker for the PC device; and
audibly outputting written content of the electronic book through the speaker.

3. The method for embedding interactive multimedia into an electronic book, the method as claimed in claim 1 further comprises the steps of:
providing a display screen for the PC device; and
visually outputting written content of the electronic book through the display screen.

4. The method for embedding interactive multimedia into an electronic book, the method as claimed in claim 1 further comprises the steps of:
providing a display screen for the PC device; and
visually outputting visual content of the electronic book through the display screen.

5. The method for embedding interactive multimedia into an electronic book, the method as claimed in claim 1 further comprises the steps of:
providing at least one piece of marketing material, wherein the piece of marketing material is contextually integrated into a specific storyline section of the electronic book;
prompting to view the piece of marketing material with the PC device,
if the PC device outputs the specific storyline section; and
outputting the piece of marketing material with the PC device,
if the PC device receives a user confirmation to view the piece of marketing material.

6. The method for embedding interactive multimedia into an electronic book, the method as claimed in claim 5 further comprises the steps of:
prompting to view the piece of marketing material with the PC device by outputting an interactive link with the specific storyline section, wherein the interactive link is associated to the specific storyline section.

7. The method for embedding interactive multimedia into an electronic book, the method as claimed in claim 5 further comprises the steps of:
providing at least one speaker for the PC device; and
outputting audible portions for the piece of marketing material through the speaker.

8. The method for embedding interactive multimedia into an electronic book, the method as claimed in claim 5 further comprises the steps of:
providing a display screen for the PC device; and
outputting visual portions for the piece of marketing material through the display screen.

9. The method for embedding interactive multimedia into an electronic book, the method as claimed in claim 5 further comprises the steps of:
providing a plurality of user profiles stored on at least one remote server, wherein a specific profile from the plurality of user profiles is associated with the PC device;
monitoring user reading habits through the PC device;
storing the user reading habits with the specific profile on the remote server; and
contextually catering the piece of marketing material to the user reading habits of the specific profile with the remote server.
